(19) United States
(12) Patent Application Publication
(10) Pub. No.: US 2019/0093588 A1
(43) Pub. Date: Mar. 28, 2019

(54) METHOD FOR DETERMINING FUEL INJECTION PROFILES

(71) Applicant: FEV Europe GmbH, Aachen (DE)

(72) Inventors: Joschka Schaub, Aachen (DE); Christian Jörg, Herzogenrath (DE); Daniel Neumann, Herzogenrath (DE)

(21) Appl. No.: 16/135,032

(22) Filed: Sep. 19, 2018

(30) Foreign Application Priority Data
Sep. 25, 2017 (DE) 102017122127.1

(51) Int. Cl. F02D 41/26; F02D 41/30; F02D 41/14; F02D 41/40

(52) U.S. Cl. CPC F02D 41/263; F02D 41/3076; F02D 41/401; F02D 41/1448; F02D 41/1402

(57) ABSTRACT

The method for determining fuel injection profiles in an internal combustion engine, comprising the steps of providing data of a setpoint combustion profile; measuring data of an actual combustion profile; and varying a fuel injection profile, such that the actual combustion profile comes closer to the setpoint combustion profile.

### CROSS-REFERENCE TO RELATED APPLICATIONS

This application is the U.S. application which claims priority of German Patent Application No. 102017122127.1 filed on Sep. 25, 2017.

### FIELD OF THE INVENTION

The present invention relates to a method for determining fuel injection profiles in an internal combustion engine, and to an engine system for determining fuel injection profiles.

The application of complex injection strategies with a plurality of injection events has the potential to improve a thermodynamic engine behaviour. However, the realization of these complex fuel injection profiles is a technical challenge in respect of calibration.

### BACKGROUND OF THE INVENTION

A combustion controller can be used directly on the engine control unit. However, such an application gives rise to particular requirements made of the control unit, which are not able to be satisfied easily by present-day standard control units.

The document DE 10 2007 012 604 A1 relates to a method for controlling an injection of an injector of a direct-injection internal combustion engine, and to a corresponding device therefor. The proposal is for a closed-loop control to be based on a cylinder pressure profile present in a manner stored with respect to a crankshaft position. The closed-loop control comprises an entire injection profile for at least one cylinder.

The document DE 10 2016 116 868 A1 relates to a method for providing at least one closed-loop control basis for an engine closed-loop control of an internal combustion engine, wherein the engine closed-loop control makes it possible to carry out a controlled setting of operating means of the internal combustion engine in a manner based on the at least one closed-loop control basis.

### SUMMARY OF THE INVENTION

The object of the present invention is to minimize a calibration complexity for complex fuel injection profiles.

In accordance with a first aspect, the object is achieved by means of a method for determining fuel injection profiles in an internal combustion engine, comprising the steps of providing data of a setpoint combustion profile; measuring data of an actual combustion profile; and varying a fuel injection profile, such that the actual combustion profile comes closer to the setpoint combustion profile. By means of the method, a fuel injection profile which can be used to realize an optimum setpoint combustion profile can be obtained in a simple and rapid manner. The given approach enables an application of the obtained fuel injection profile on simple, established control units.

In one technically advantageous embodiment of the method, the setpoint combustion profile is given by a pressure in the combustion chamber as a function of the crank angle. This affords the technical advantage, for example, that the actual combustion profile can be angularly accurately resolved and adapted for a cycle.

In a further technically advantageous embodiment of the method, the actual combustion profile is measured by a cylinder pressure sensor. This affords the technical advantage, for example, that the actual combustion profile can be determined in a simple manner.

In a further technically advantageous embodiment of the method, the deviation between the setpoint combustion profile and the actual combustion profile is minimized. This affords the technical advantage, for example, that an optimally adapted fuel injection profile is obtained.

In a further technically advantageous embodiment of the method, the deviation between the setpoint combustion profile and the actual combustion profile is determined on the basis of a sum of the square individual deviations. This affords the technical advantage, for example, that the deviation can be determined in a simple and rapid manner.

In a further technically advantageous embodiment of the method, the setpoint combustion profile is predefined as a function of an operating point of the engine. This affords the technical advantage, for example, that respectively adapted fuel injection profiles are obtained for different operating points of the internal combustion engine.

In a further technically advantageous embodiment of the method, the fuel injection profile is converted into actuation data for an injector. This affords the technical advantage, for example, that actuation data can be transmitted directly into a control unit for actuating injectors.

In a further technically advantageous embodiment of the method, the actuation data are written to an electronic control unit for actuating injectors. This affords the technical advantage, for example, that the control data can be used directly for actuating injectors for fuel injection.

In a further technically advantageous embodiment of the method, the electronic control unit can select the actuation data as a function of an operating point of the internal combustion engine. This affords the technical advantage, for example, that the injectors are actuated efficiently even at different operating points.

In accordance with a second aspect, the object is achieved by means of an engine system comprising a data memory for providing data of a setpoint combustion profile; a sensor for measuring data of an actual combustion profile; and a combustion controller for varying a fuel injection profile, such that the actual combustion profile comes closer to the setpoint combustion profile. The technical advantages afforded by the engine system are the same as those afforded by the method according to the first aspect.

In one technically advantageous embodiment of the engine system, the engine system comprises a cylinder pressure sensor for measuring the actual combustion profile. This likewise affords the technical advantage, for example, that the actual combustion profile can be determined in a simple manner.

In a further technically advantageous embodiment of the engine system, the combustion controller is configured to determine the deviation between the setpoint combustion profile and the actual combustion profile. This affords the technical advantage, for example, that the deviation between the setpoint combustion profile and the actual combustion profile can be determined.

In a further technically advantageous embodiment of the engine system, the combustion controller is configured to convert the fuel injection profile into actuation data for an injector. This likewise affords the technical advantage, for example, that the actuation data can be used in a control unit for an injector.

In a further technically advantageous embodiment of the engine system, the combustion controller is configured to write the actuation data to a control unit. This likewise affords the technical advantage, for example, that the control unit can be configured in a simple manner.

In a further technically advantageous embodiment of the engine system, the combustion controller is formed by a digital circuit or a software module. This affords the technical advantage, for example, that a rapid determination of the fuel injection profile is achieved.

Exemplary embodiments of the invention are illustrated in the drawings and are described in greater detail below.

### BRIEF DESCRIPTION OF THE DRAWINGS

FIG. 1 shows a schematic illustration of the method;

FIG. 2 shows a block diagram of the method; and

FIG. 3 shows a schematic illustration of an engine system.

### DETAILED DESCRIPTION OF THE PREFERRED EMBODIMENTS

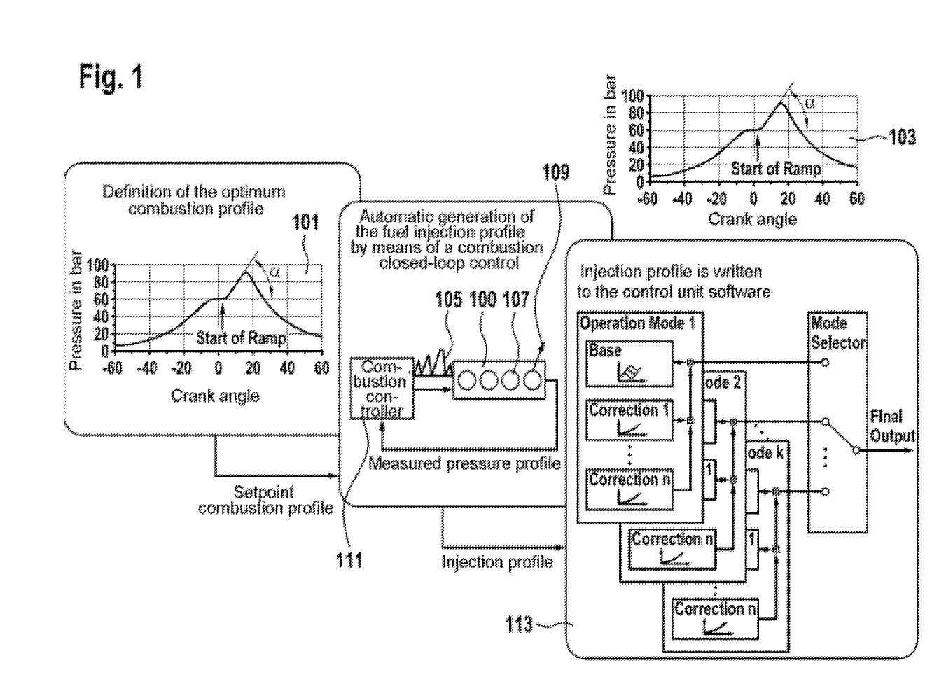

FIG. 1 shows a schematic illustration of the method for determining fuel injection profiles in an internal combustion engine 100. The internal combustion engine 100 is for example a diesel engine, wherein the injected fuel undergoes auto-ignition by means of the combustion air in a combustion chamber 107, said air being heated by compression. In general, however, the internal combustion engine can be any fuel-operated engine in which specific fuel injection profiles are used.

In order to minimize the calibration complexity for the complex fuel injection profiles, firstly a setpoint combustion profile 101 is predefined, on the basis of which a closed-loop control of the entire combustion process is carried out. An optimum setpoint combustion profile 101 is defined as a function of the operating point, such as, for example, the rotational speed or load, and/or further conditions, such as, for example, the engine temperature, the combustion mode or ambient conditions. This setpoint combustion profile 101 can be synthetically defined and predefined for example as a crankshaft angle-resolved pressure profile or heat profile.

In the synthetic composition of the setpoint combustion profile 101, individual characteristics are taken into account, such as, for example, the peak pressure, the peak pressure gradient, the maximum heat liberation or the combustion centroid position. These combustion characteristics are typically determined experimentally in regard to an optimum combustion behaviour. Possible further indicators are combustion noise, a fuel consumption, an efficiency or an emission behaviour. In this way, it is possible to provide a setpoint combustion profile 101 that is technically particularly advantageous with regard to the engine or consumption properties. The setpoint combustion profile 101 can be predefined as a data set having data in digital form, for example as a set of value pairs that assign a pressure to each crank angle.

As soon as the setpoint combustion profile 101 has been determined, it is adjusted by an electronic combustion controller 111 at the internal combustion engine. The combustion controller 111 automatically generates a fuel injection profile 105. The fuel injection profile 105 comprises a number of different injection events having respective injection start and end times.

Afterwards, the actual combustion profile 103 is measured in the internal combustion engine 100. By way of example, a feedback signal can be provided as actual combustion profile 103 by means of a cylinder pressure sensor 109. The cylinder pressure sensor 109 comprises for example a piezo-element that generates a corresponding voltage drop depending on the pressure in the combustion chamber. In general, however, all devices that allow the determination of the respective variables in the combustion chamber can be used as cylinder pressure sensor 109. Furthermore, the internal combustion engine 100 comprises a device for determining the instantaneous angle of the crankshaft (crank angle). As a result, it is possible for example to measure the measured pressure in the combustion chamber 107 as a function of the crank angle as actual combustion profile 103. In this case, the actual combustion profile 103 can also be obtained as a data set having data in digital form, for example as a set of value pairs that assign a pressure to each crank angle.

The actual combustion profile 103 is subsequently compared with the setpoint combustion profile 101. The deviation is determined between the setpoint combustion profile 101 and the actual combustion profile 103. This can be carried out for example on the basis of the least square method, wherein the individual deviations between the two profiles are squared and then summed. The higher the calculated value, the higher the deviation between the combustion profiles 101 and 103.

The electronic combustion controller 111 evaluates the calculated deviation and varies the fuel injection profile 105 such that the actual combustion profile 103 comes closer to the setpoint combustion profile 101. For this purpose, the electronic combustion controller 111 can vary the fuel injection profile 105 used. By way of example, the combustion controller 111 shifts the respective injection start and end times, increases or decreases the number of injection events or varies the spacing between the injection events. These variations of the fuel injection profile 105 can be carried out on the basis of a predefined algorithm, such that a local or global minimum for the deviation is obtained.

The variation process can be repeated until the deviation between the actual combustion profile 103 and the setpoint combustion profile 101 becomes minimal. The combustion controller 111 identifies the associated fuel injection profile 105 for the minimal deviation. The combustion controller 111 is formed for example by a digital electrical circuit or a corresponding software module.

If the best suited fuel injection profile 105 has been found, the actuation data for the injectors can be calculated from the fuel injection profile 105. By way of example, the actuation signals are obtained by means of a predefined prior temporal shift relative to the fuel injection profile 105 in order to take account of a reaction time of the injectors.

The calculated actuation signals can finally be transmitted and written to the digital memory of a control unit 113, such that the latter can realize the determined actual combustion profile 103 with the smallest deviation with respect to the setpoint combustion profile 101 by actuation of the injectors. The control unit 113 calibrated in this way can finally be used for controlling the internal combustion engine 100, without the combustion controller 111 used previously being required for this purpose.

Furthermore, for each operating point of the internal combustion engine 100 respective actuation data can be written to the control unit 113, such that the control unit 113 can select suitable actuation data depending on the operating point of the internal combustion engine 100. An emission behaviour of a drivetrain with direct-injection spark-ignition and diesel engine can be improved as a result.

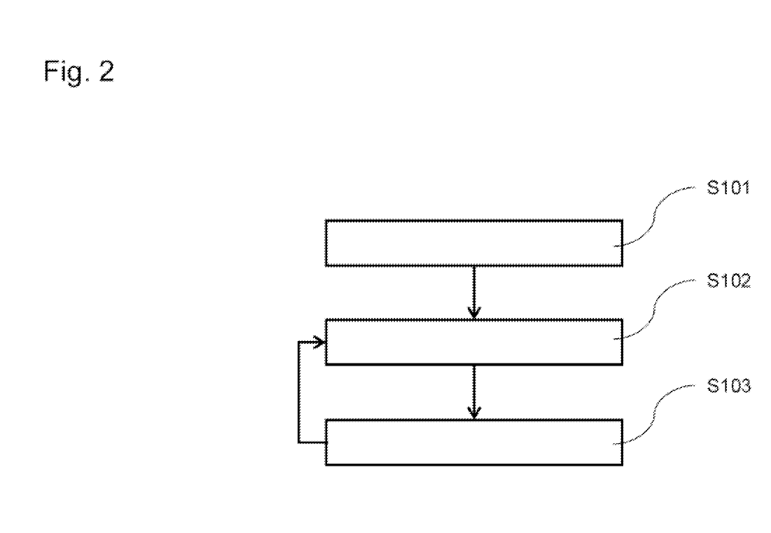

FIG. 2 shows a block diagram of the method for determining fuel injection profiles in the internal combustion engine 100. In step S101, firstly data of the setpoint combustion profile 101 are provided to the combustion controller 111. In step S102, the data of the actual combustion profile 103 are measured and provided to the combustion controller 111. The combustion controller 111 determines and quantifies the deviation between the setpoint combustion profile 101 and the actual combustion profile 103. In step S103, the fuel injection profile 105 is varied or modified, such that the actual combustion profile 103 comes closer to the setpoint combustion profile 101. Steps S102 and S103 can then be repeated until the deviation between the setpoint combustion profile 101 and the actual combustion profile 103 lies below a predefined limit value.

As a result, a fuel injection profile 105 which generates the setpoint combustion profile 101 as accurately as possible can be obtained rapidly and efficiently.

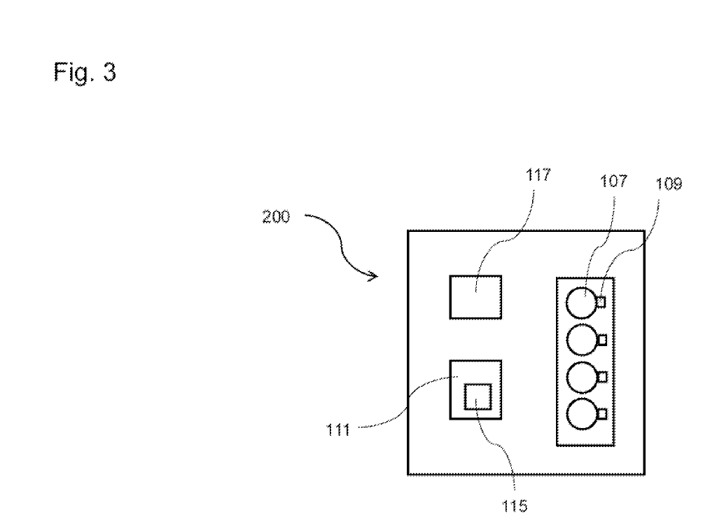

FIG. 3 shows a schematic illustration of an engine system 200 for determining fuel injection profiles 105. The engine system 200 comprises a data memory 117 for providing data of the predefined setpoint combustion profile 101 and for storing data about the fuel injection profile 105, such as, for example, a hard disk or a random access memory (RAM). In addition, the engine system 200 comprises a sensor 203 for measuring data of the actual combustion profile 103 in the combustion chamber 107. The combustion controller 111 serves for varying the fuel injection profile 105, such that the actual combustion profile 103 comes closer to the setpoint combustion profile 101.

The combustion controller 111 comprises a processor 115 for processing the data of the setpoint combustion profile 101 and of the actual combustion profile 103 and for calculating the deviation between the setpoint combustion profile 101 and the actual combustion profile 103. In addition, the processor is able to vary the stored fuel injection profile 105 in such a way that the deviation between the setpoint combustion profile 101 and the actual combustion profile 103 decreases. As a result, the setpoint combustion profile 101 can be obtained by the fuel injection profile 105 in a simple manner.

The respective, operating point-dependent fuel injection profile 105 is thus determined by means of the combustion controller 111 in the engine calibration phase at the engine test bed by means of a development control unit or directly by means of a test bed automation. The resultant families of characteristic curves for the fuel injection profile 105 are then transmitted to the standard control unit 113. The control unit 113 is then able to actuate the internal combustion engine 100, without the latter requiring a cylinder pressure sensor 109 for this purpose. However, a cylinder pressure sensor 109 can optionally be added.

All features explained and shown in association with individual embodiments of the invention can be provided in different combinations in the subject matter according to the invention in order to realize simultaneously the advantageous effects thereof.

All method steps can be implemented by devices suitable for carrying out the respective method step. All functions implemented by substantive features can be a method step of a method.

The scope of protection of the present invention is given by the claims and is not restricted by the features explained in the description or shown in the figures.

1. A method for determining fuel injection profiles in an internal combustion engine, comprising the following steps:
providing data of a setpoint combustion profile;
measuring data of an actual combustion profile; and
varying a fuel injection profile, such that the actual combustion profile comes closer to the setpoint combustion profile.

2. The method according to claim 1, wherein the setpoint combustion profile is given by a pressure in the combustion chamber as a function of the crank angle.

3. The method according to claim 1, wherein the actual combustion profile is measured by a cylinder pressure sensor.

4. The method according to claim 1, wherein the setpoint combustion profile is predefined as a function of an operating point of the engine.

5. The method according to claim 1, wherein the fuel injection profile comprises a number of different injection events having respective injection start and end times, and wherein the combustion controller varies the respective injection start and end times, the number of injection events and/or the spacing between the injection events such that a local or global minimum for the deviation is obtained.

6. The method according to claim 1, wherein the fuel injection profile is converted into actuation data for an injector, and the actuation data are written to an electronic control unit for actuating injectors.

7. The method according to claim 5, wherein the electronic control unit can select the actuation data as a function of an operating point of the internal combustion engine.

8. The method Method according to claim 6, wherein the respective, operating point-dependent fuel injection profile is determined by means of the combustion controller in the engine calibration phase by means of a development control unit or directly by means of a test bed automation, and wherein the resultant families of characteristic curves for the fuel injection profile are transmitted to the electronic control unit, with the result that the control unit calibrated in this way can be used for controlling the internal combustion engine, without the combustion controller used previously being required.

9. The engine system for determining fuel injection profiles, comprising:
a data memory for providing data of a setpoint combustion profile;
a sensor for measuring data of an actual combustion profile; and
a combustion controller for varying a fuel injection profile, such that the actual combustion profile comes closer to the setpoint combustion profile.

10. The engine system according to claim 9, wherein the engine system comprises the sensor for measuring the actual combustion profile of cylinder pressure.

11. The engine system according to claim 9, wherein the combustion controller is configured to determine the deviation between the setpoint combustion profile and the actual combustion profile.

12. The engine system according to claim 9, wherein the combustion controller is configured to convert the fuel injection profile into actuation data for an injector and to write said data to a control unit.

13. The engine system according to claim 9, wherein the control unit is configured to actuate the internal combustion engine and in this case to select suitable actuation data depending on the operating point of the internal combustion engine, without the combustion controller used previously being required for this purpose.
